(19) United States
(12) Patent Application Publication
(10) Pub. No.: US 2004/0212626 A1
(43) Pub. Date: Oct. 28, 2004

(54) System and a method for user interaction

(76) Inventors: Urban Lyxzen, Vasteras (SE); Johan Dahlin, Vasteras (SE)

Correspondence Address: VENABLE, BAETJER, HOWARD AND CIVILETTI, LLP, P.O. BOX 34385, WASHINGTON, DC, 20043-9998, US

(21) Appl. No.: 10/481,599

(22) PCT Filed: Jun. 27, 2002
(86) PCT No.: PCT/SE02/01274

(30) Foreign Application Priority Data
Jun. 29, 2001 (SE) 0102318-3
Jun. 29, 2001 (SE) 0102319-1

(51) Int. Cl. G09G 5/02

(52) U.S. Cl. 345/589

(57) ABSTRACT

A system for making possible user interaction with objects on a screen, which system comprises means (9) for displaying digitally generated objects (3) on a screen (1). The objects (3) are displayed in two or more transparent and mutually superimposed layers (7a, 7b), which layers comprise an active layer (7a) and one or several passive layers (7b). A layer shifting means (6) that is activatable by a user will when activated produce a shift of layers so that the active layer (7a) is changed into a passive layer (7b) and one of the passive layers (7b) is changed into an active layer (7a). The invention further relates to a method for making possible user interaction with objects on a screen, a computer program comprising software for implementing the method according to the invention, and a computer-readable medium having stored thereon a computer program intended to make a computer implement the method according to the invention. The invention also relates to the use of the inventive system for programming the movements of an industrial robot.

### FIELD OF THE INVENTION AND PRIOR ART

The present invention relates to a system for making possible user interaction with objects on a screen, which system comprises a screen and means for displaying digitally generated objects on the screen. The invention further relates to a method for making possible user interaction with objects on a screen. The invention also relates to a computer program directly loadable into the internal memory of a computer, which computer program comprises software for implementing the method according to the invention, and a computer-readable medium having stored thereon a computer program intended to make a computer implement the method according to the invention. The invention also relates to the use of the inventive system for programming the movements of an industrial robot.

The present invention further relates to a system for making possible user interaction with objects on a screen, which system comprises a screen and means for displaying digitally generated information objects and at least one digitally generated function object on the screen, the function object being activatable by a user through a pointing device for control of a system function. The invention further relates to a method for making possible user interaction with objects on a screen. The invention also relates to a computer program directly loadable into the internal memory of a computer, which computer program comprises software for implementing the method according to the invention, and a computer-readable medium having stored thereon a computer program intended to make a computer implement the method according to the invention. The invention also relates to the use of the inventive system for programming the movements of an industrial robot.

A large number of different types of applications where a person through a pointing device, for instance in the form of a computer mouse or the like, interacts with function objects displayed on a screen in order to activate different types of system functions have been developed and come into use during the last years. The function objects are for instance scroll bars which, when activated by means of a pointing device, will produce a displacement vertically or laterally of information objects displayed on the screen. When for instance a conventional word processing program executed in a personal computer (PC) is involved, an activation of said type of scroll bars will produce a displacement in desired direction of text displayed on the screen.

Concurrently with the generally increasing computerization the needs for presenting different types of information on a screen in an effective and user-friendly manner are increased. In certain applications it is desirable to be able to present as much information as possible to a user on a given screen area, so as to for instance facilitate for the user to perform a working operation that is controlled or assisted through the screen. In this type of applications it is often desirable to make possible for the user to actively interact with the objects displayed on the screen. The information in question is for instance displayed on different display sheets, which the user is able to browse through for instance by means of a pointing device, such as a computer mouse or the like, or by means of function buttons on a keyboard. With this type of solution it is normally difficult for the user to know where a certain information content is to be found, and a time consuming and trying browsing to-and-fro between different display sheets is often required before the wanted information is found and made to appear on the screen.

In certain applications of the aboveindicated type, the available screen area is also limited. The programming of the movements of an industrial robot by means of a programming unit, which is hand carried and communicates with the control arrangement of the robot, may be mentioned as an example of such an application. Through a screen on the hand carried programming unit it is possible for an operator to study the input program code that controls how the different parts of the robot is moving, and through some kind of input device it is possible for the operator to input new program code or edit previously input program code. As this type of robot programming often takes place under rough external environmental conditions and the risks of the hand carried programming unit being exposed to impacts and hits are considerable, it is desirable to use a screen in the programming unit having a screen area as small as possible. The durability of the type of screen here in question is namely larger the smaller the dimension of the screen. A further advantage with a screen of small dimensions is that the screen requires less current supply the smaller it is. Hereby, the charge amount of the programming unit can be limited when using a small screen, which in its turn results in decreased explosion hazards when the programming takes place in an environment with high explosion danger. The requirements of a small screen area will make it more difficult to present through the screen, in a well-arranged and user-friendly manner, the information required to the user.

### OBJECT OF THE INVENTION

An object of the present invention is to achieve a system offering improved possibilities to effectively use an available screen area. The inventive idea also includes a system offering an effective use without having to forgo the possibilities for a system user, for instance a robot programmer, of interacting with the objects displayed on the screen in question.

### SUMMARY OF THE INVENTION

According to the invention said object is achieved by means of a system having the features indicated in the characterizing part of claim 1.

The inventive solution implies that it is possible for the user to simultaneously perceive on the screen objects that are present in several different layers, and for the user to control the mutual order between the layers so as to for instance accentuate the objects that are present in a certain layer before the objects of the other layers. Thereby, it is i.a. offered an excellent possibility for the user, in a simple and clear manner, of “navigating up to” the desired information in a certain amount of information displayable through a screen.

According to a preferred embodiment of the invention, the active objects, i.e. the objects that are present in the active layer, are displayed with a higher spatial frequency and/or display sharpness than the passive objects, i.e. the objects that are present in a passive layer. In this case, the active objects can be considered to be in focus for the eyes of the user, whereas the passive objects are out of focus but however still perceivable for the user when the user looks at the image shown on the screen. The inventive solution makes it possible for the user to perceive the passive objects and the information comprised therein without any larger part of the brain capacity of the user having to be used for this. Hereby, it is possible for the user to concentrate on studying, analyzing and manipulating the active objects and their information content and simultaneously, on a lower level of consciousness, acquaint himself with the passive objects and their information content. It is realized that a shift of layers in this case will imply that the objects that are present in the layer which constituted the active layer before the shift of layers, i.e. the objects that before the shift of layers were displayed with higher spatial frequency and/or display sharpness than the objects in the other layers, after the shift of layers will be displayed with a lower spatial frequency and/or display sharpness as compared to the objects that are present in the layer which after the shift of layers constitutes the active layer. Consequently, it is possible for the user to control through the layer shifting means which layer's objects that are to be made to appear more clearly than the other layers' objects.

According to a further preferred embodiment of the invention, the active objects are displayed in a stronger shade of colour than the passive objects. It is realized that this will also offer the user a possibility of controlling through the layer shifting means which layer's objects that are to be made to appear more clearly than the other layers' objects.

According to a further preferred embodiment of the invention, the different layers comprise mutually co-operating objects, which are adapted to co-operate in such a manner that an operation initiated by the user on an object present in a first layer will produce an operation on a co-operating object present in a second layer. This will for instance offer the user a possibility of immediately, through information displayed on the screen, learning how an alteration of a function parameter displayed on the screen in a first layer will affect an object controlled by this function parameter and displayed in a second layer. Said function parameter is for instance included in a program code that controls the movements of a robot, the robot, which consequently constitutes the object controlled by the function parameter, being displayed in said second layer. In this manner it will be possible for a robot programmer to learn on the screen how the movements of the robot are affected by a certain alteration of said program code. Furthermore, a robot image displayed in a layer on the screen is suitably provided with a colour marking indicating the part of the robot that is controlled by a program sequence displayed in another layer on the screen.

It is included in the inventive idea that the respective function object as to its surface size is adapted for co-operation with a pointing device in the form of a finger. In one embodiment the screen is a touch screen, in which case the respective function object as to its surface size is adapted for co-operation with a pointing device in the form of a finger as above indicted.

The inventive solution further implies that the function object or objects, which are displayed on the screen and by means of which the user through a pointing device controls different types of system functions, are visible for and activatable by the user without their display on the screen entailing a limitation of the screen area available for display of information objects. In this manner, it will consequently be possible to use a part as large as possible of the screen area for displaying information objects. Since no part of the screen area has to be reserved only for display of said function objects, the inventive solution entails that it is possible for the user to use a screen with a smaller screen area for showing a certain amount of information as compared to conventional solutions where a part of the screen area is reserved only for display of said function objects.

The expression function object will in this description and the subsequent claims refer to an object that is digitally generated and displayed or displayable on a screen, which object is activatable by a user by means of a pointing device, in the form of a computer mouse, a finger, a pointing pen or the like, for control of a system function. Said system function is for instance of a type that will produce some kind of alteration of the objects which are displayed or intended to be displayed on the screen, or some kind of alteration in how these objects are displayed on the screen, such as for instance a system function for producing a size alteration of the objects displayed on the screen. It is also possible to let said system function be of a type that will not directly affect the objects displayed on the screen or the form for their display, such as for instance a system function for initiating a print-out of information on a printer or initiating a storing of for instance program code on a storage medium.

The expression information object will in this description and the subsequent claims refer to an object that is digitally generated and displayed or displayable on a screen, which object carries an information content intended for a user. The information object is possibly affectable by the user by means of a pointing device after the user first having marked the information object on the screen by means of a pointing device. The information object is for instance an image, a symbol, an individual character, a combination of characters etc.

According to another preferred embodiment of the invention, at least one function object is adapted to control a scrolling function, an activation of this function object by means of the pointing device initiating a movement vertically or laterally of at least some of the information objects displayed on the screen. Hereby, it is possible to implement a conventional image scrolling function in an image displayed on the screen without any part of the screen area having to be reserved only for displaying the function objects related to the image rolling function, such as for instance scrolling bars. Since the image scrolling functions in accordance with the invention are implementable in a completely software-based manner, the need of hardware-based function members for control of the image scrolling on a screen is eliminated, which results in cost savings.

According to a further preferred embodiment of the invention, the screen is a touch screen, the respective function object preferably being adapted as to its surface size for co-operation with a pointing device in the form of a finger. The expression touch screen will in this description and the subsequent claims refer to a screen adapted to be able to receive control commands by the user pointing or lightly pressing against parts of the screen with a pointing device, for instance in the form of one of the fingers of the user. With the inventive solution, the area available for display of information objects will not be affected by the surface size of a function object displayed on the screen. Hereby, a great latitude is obtained concerning the choice of surface size of a function object and its localization on the screen. This is particularly advantageous when a touch screen intended for co-operation with a finger is used, since a finger normally constitutes a relatively coarse pointing device. By letting the function object being displayed on a relatively large area of the screen and on an area of the screen that is easily accessible for the finger of the user, the activation of the function object by the user is considerably facilitated. It has previously been proven that a user for activation of function objects, which are small as to its area and are displayed on a screen, tends to use a spike, a pen or any other pointing object instead of a finger, which implies a risk of scratching of the screen surface. With the inventive solution, it is possible to considerably reduce these risks, since it is offered improved possibilities to allot a function object a large pressing area favouring finger manoeuvring.

According to a further preferred embodiment of the invention, the inventive system is a programming device, preferably for programming the movements of an industrial robot. The programming device is with advantage adapted to communicate with the control unit of the robot through a wireless connection, for instance implemented by means of blue-tooth technique. As previously mentioned, hand carried programming units are in some cased used when programming the movements of an industrial robot, in which case it is desirable to reduce the size of the screen of the programming unit as far as possible. It is realized that the inventive solution is very advantageous to use in this application.

Even though the inventive solution is particularly favourable for use together with touch screens, it is of course also applicable for use together with conventional screens where the user through a pointing device in the form of a computer mouse or the like controls the localization of a marker displayed on the screen. In this case, a function object is activated either directly when the marker is moved over the function object or when the user presses some kind of function button after the marker has been localized onto the function object by means of the pointing device. Systems offering the combined possibility of activating a function object with the above described touch screen function as well as with the above described marker function are of course possible within the scope of the invention.

The invention also relates to a method for making possible user interaction with objects on a screen according to claim 23.

The invention also relates to a computer program directly loadable into the internal memory of a computer according to claim 45, which computer program comprises software for implementing the inventive method.

The invention also relates to a computer-readable medium according to claim 46, which medium has stored thereon a computer program intended to make a computer implement the inventive method.

The invention also relates to the use of the inventive system for programming the movements of an industrial robot.

Further preferred embodiments of the invention will appear from the dependent claims and the subsequent description.

The expression function object will in this description and the subsequent claims refer to an object that is digitally generated and displayed or displayable on a screen, which object is activatable by a user by means of a pointing device, in the form of a computer mouse, a finger, a pointing pen or the like, for control of a system function. Said system function is for instance of a type that will produce some kind of alteration of the objects which are displayed or intended to be displayed on the screen, or some kind of alteration in how these objects are displayed on the screen, such as for instance a system function for producing a size alteration of the objects displayed on the screen. It is also possible to let said system function be of a type that will not directly affect the objects displayed on the screen or the form for their display, such as for instance a system function for initiating a print-out of information on a printer or initiating a storing of for instance program code on a storage medium.

The expression information object will in this description and the subsequent claims refer to an object that is digitally generated and displayed or displayable on a screen, which object carries an information content intended for a user. The information object is possibly affectable by the user by means of a pointing device after the user first having marked the information object on the screen by means of a pointing device. The information object is for instance an image, a symbol, an individual character, a combination of characters etc.

### BRIEF DESCRIPTION OF THE DRAWING

The invention will in the following be more closely described by means of embodiment examples, with reference to the appended drawing. It is shown in:

FIG. 1 a very schematical illustration of how objects displayed on a screen in accordance with the invention are displayed in different layers,

FIG. 2 a schematical illustration of how the objects displayed in the different layers illustrated in FIG. 1 will appear for a user who is watching the screen,

FIG. 3 a schematically shown screen surface illustrating a practical application of the inventive system,

FIGS. 4-6 schematically illustrated screen areas provided with information objects and function objects,

FIG. 7 a simplified block diagram illustrating components included in an embodiment of the system according to the invention,

FIG. 8 a schematic illustration of a programming unit included in a preferred embodiment of the system according to the invention, and

FIG. 9 a schematic illustration of a programming device when used for programming the movements of an industrial robot.

### DETAILED DESCRIPTION OF PREFERRED EMBODIMENTS

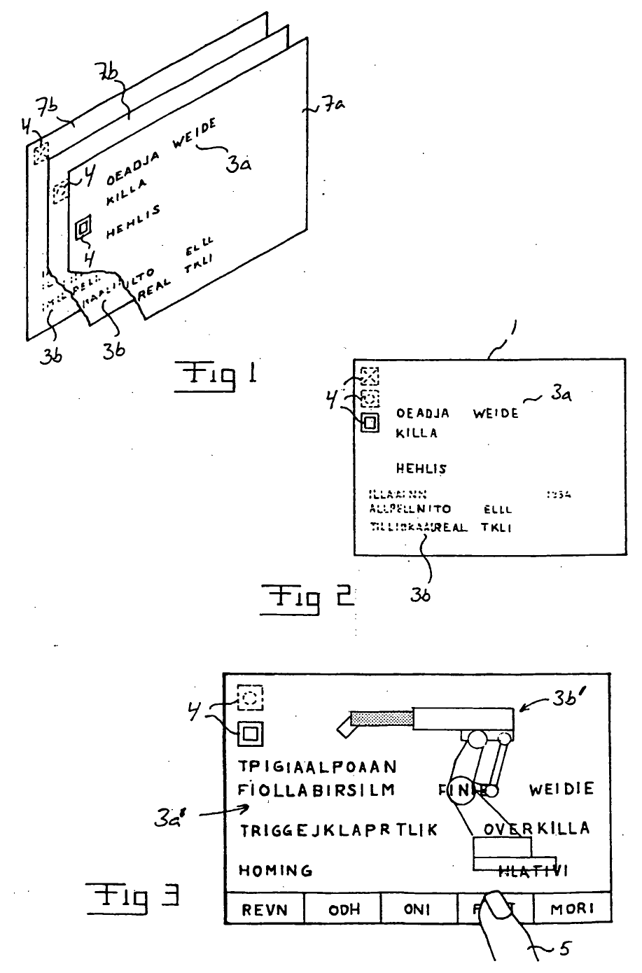

The inventive system comprises means for displaying digitally generated objects on a screen 1, which objects consist of function objects and/or information objects. According to the invention, said display means are adapted to display the objects 3 in two or more transparent and mutually superimposed layers 7a, 7b, which layers comprise an active layer 7a and one or several passive layers 7b. This display of objects in several layers is illustrated very schematically in FIG. 1. In this case, the objects 3 are intended to be displayed in an active layer 7a and two passive layers 7b, but it is also possible to let the number of passive layers be larger as well as smaller than two. That certain objects 3 are displayed in one and the same layer implies that they are concatenated with each other and affectable in group in such a manner that for instance a displacement of the layer vertically or laterally on the screen results in a corresponding displacement of all objects that are present in the layer and that a removal of the layer from the screen results in a removal from the screen of all objects that are present in the layer. It is of course also possible to let the objects that are present in one and the same layer be commonly affectable in many other manners according to requirements and application. That certain objects are present in one and the same layer will however not exclude that these objects are also individually affectable by the user.

In the following, the denomination “active objects” will be used for the objects that are displayed in a so-called active layer and the denomination “passive objects” for the objects that are displayed in a so-called passive layer. In FIG. 1 the reference 3a is used for indicating active objects and the reference 3b for indicating passive objects.

The layers 7a, 7b are in FIG. 1, for illustrative purposes, reproduced as being separate physical layers, but in the reality the different layers are of course only of virtual character. FIG. 2 shows the objects 3a, 3b displayed in the different layers 7a, 7b as they are meant to appear to a user watching the screen 1 in question.

The means 9 for displaying objects 3a, 3b on the screen 1 consist for instance of conventional computer components, such as a data processing unit 13 connected to the screen 1, storage medium 14, application programs 11 executable in the data processing unit 13 etc. These components are illustrated very schematically in FIG. 7.

The display means 9 are adapted to display the active objects 3a in such a manner that they are visually distinguished from the passive objects 3b. In this manner it is possible to get the active objects 3a to appear in such a manner that they are distinguished from the passive objects for a user who is watching the objects displayed on the screen 1. The layer comprising the objects that are of primary interest to the user at a certain moment, for instance the objects the user at the moment intends to manipulate in some way, is intended to constitute the for the time being active layer 7a. The active objects 3a are therefore suitably displayed in a visually more conspicuous manner than the passive objects 3b, i.e. the active objects 3a are suitably displayed in such a manner that they will appear more clearly than the passive objects to a person watching the screen 1.

In order to visually distinguish the active objects 3a from the passive objects 3b, the active objects 3a are for instance displayed with a display sharpness or spatial frequency that distinguishes them from the passive objects 3b. It is also possible to use hatching in order to visually distinguish active and passive objects. It is also possible to achieve the visual distinction by displaying the active objects 3a in a shade of colour that distinguishes them from the passive objects 3b. It is of course also possible to use different combinations of distinguishing display sharpness, spatial frequency, hatching and shade of colour in order to achieve the desired visual distinction.

In order to accentuate the objects in the active layer 7a and make these appear more clearly to the user than the objects in the passive layers 7b, the active objects 3a are preferably intended to be displayed with a spatial frequency and/or display sharpness that is higher than the spatial frequency and/or display sharpness of the passive objects 3b, and/or in a shade of colour that is stronger than the shade of colour of the passive objects 3b. The higher display sharpness of the active objects 3a is for instance produced in that these are displayed with a higher resolution than the passive objects 3b. When objects displayed in several different passive layers 7b are simultaneously displayed on the screen 1 it is of course also possible, if so desired, to distinguish the objects in the different passive layers from each other by letting the objects in a certain passive layer be displayed in such a manner that they are visually distinguished from the objects in another passive layer.

It is of course also possible to use layers that are kept hidden for the user and are made to appear to the user as an active or passive layer only when the user so orders, i.e. layers that are kept hidden while the objects in an active layer and one or several passive layers are displayed on the screen, and the objects of which are made to be displayed on the screen as passive or active objects when so desired.

The inventive system further comprises a layer shifting means, which is activatable by the user and adapted to produce a shift of layers when being activated so that the active layer 7a is changed into a passive layer 7b and one of the passive layers 7b is changed into an active layer 7a. During this shift of layers, the layer shifting means 6 is adapted to control the display means 9 to shift shade of colour and/or spatial frequency and/or display sharpness and/or hatching of the objects displayed in the layer that is changed from an active into a passive layer at the shift of layers and in the layer that is changed from a passive into an active layer at the shift of layers. In this manner it is possible for the user to control which layer that at a certain given moment is to constitute the active layer, and consequently which layer's object that at a certain given moment is to be made to appear most clearly to the user.

The layer shifting means, which is schematically indicated at 6 in FIG. 7, comprises a program sequence stored on a storage medium, which program sequence will perform the abovedescribed shift of layers when being activated. The layer shifting means further comprises a control member communicating with said program sequence, by means of which control member it is possible for the user to activate the program sequence to perform a desired shift of layers. This control member is for instance software-based and consists of one or several function objects displayed on the screen, which objects are activatable by the user through a pointing device, such as a computer mouse or the like, by means of which the user controls the localization of a marker displayed on the screen. In this case, a function object 4 is either activated directly when the marker is moved over the function object or when the user presses some kind of function button after the marker has been localized on the function object by means of the pointing device. According to a preferred embodiment, the previously mentioned display means 9 are adapted to display on the screen 1 a function object 4, included in the layer shifting means, for the respective layer 7a, 7b. In the embodiment illustrated in FIGS. 1 and 2, each of these function objects 4 consists of an icon. It is possible to display all icons in one and the same layer but the respective icon is with advantage displayed in the layer associated with the icon. It is for instance also possible to let said function object 4 consist of a browsing flap or the like associated with the respective layer. By activating an icon and a browsing flap, respectively, the user initiates a shift of layers so that the layer associated with the icon/flap is changed into an active layer and the previous active layer is changed into a passive layer.

It is also possible to let the control member included in the layer shifting means 6 be a hardware-based control member and for instance consist of a function lever or one or several function buttons on a keyboard. In this case, each layer is for instance associated with a specific function button. Systems where the layer shifting means comprises software-based control members in combination with hardware-based control members are of course also possible within the scope of the invention.

According to a preferred embodiment of the invention, the screen 1 is a so-called touch screen, and a function object 4 included in the layer shifting means is in this case adapted to be activated in that the user with his finger 5, or any other pointing device, presses against the area of the screen surface that is covered by the function object 4 in question. In this case, the touch screen consequently has sensors that are detecting pressure. It is however also possible to let the touch screen be provided with sensors that do not require any direct touch of the screen 1 for activation of a function object. In the latter case, the screen is for instance provided with sensors, such as photocells, which detect a light beam from a light beam emitting pointing device directed against an area of the screen, or which detect the shadow from a pointing device placed in front of an area of the screen. It is of course also possible to let the screen be provided with other types of sensors detecting that the pointing device is placed in front of or directed against an area of the screen. When a touch screen is used, the respective function object 4 is suitably adapted as to its surface size for co-operation with a pointing device 5 in the form of a finger. It is of course also possible to let the screen be provided with other types of sensors detecting that a pointing device is placed in front of or directly against an area of the screen.

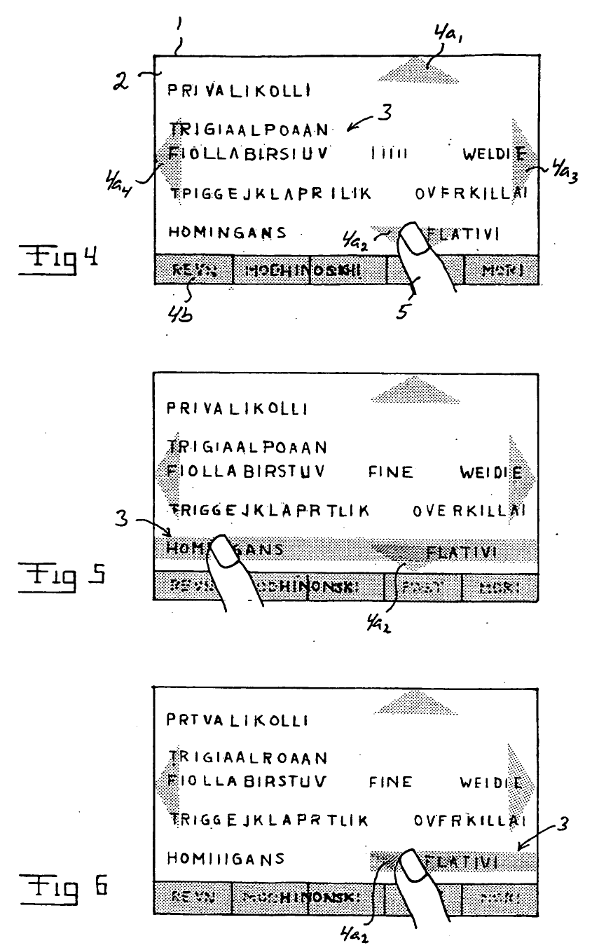

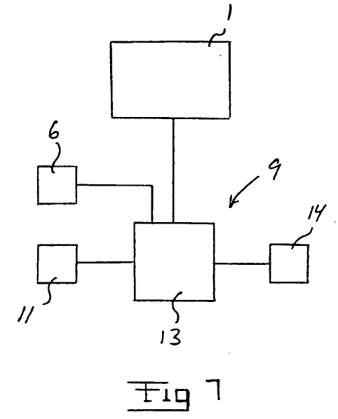

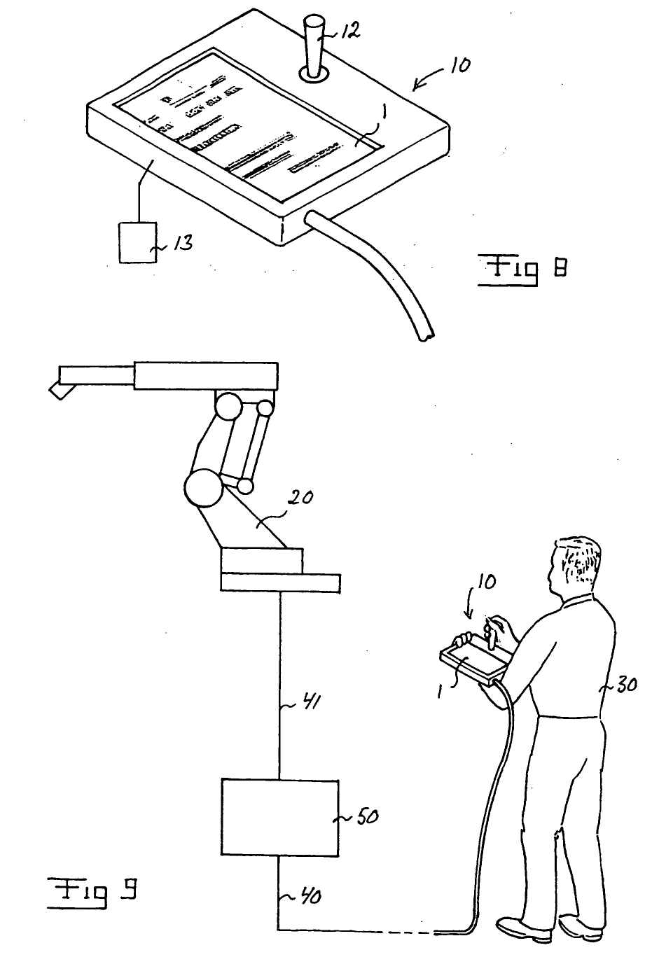

According to a preferred embodiment of the invention, the different layers 7a, 7b comprise mutually co-operating objects 3a′, 3b′, which are adapted to co-operate in such a manner that an operation initiated by the user, for instance by means of a pointing device, on an object 3a′, 3b′ present in a first layer 7a, 7b will produce an operation on a co-operating object 3b′, 3a′ present in a second layer 7b, 7a. A marking performed by the user on a first object 3a′ in a first layer 7a will for instance result in an alteration, which is visible to the user and illustrative for the application in question, of a second object 3b′ in a second layer 7b. The objects 3a′, 3b′ in question are in this case interconnected through a program sequence, which, when the first object 3a′ is marked or in any other manner affected by the user, will perform a predetermined alteration of the second object 3b′. Said operation may for instance imply that the user alters a function parameter displayed on the screen 1 in a first layer, whereupon it is possible for the user to perceive on the screen how this alteration affects an object which is controlled by this function parameter and displayed in a second layer. In FIG. 3, an application relating to robot programming is illustrated, where for instance program code 3a′ controlling the movements of an industrial robot is displayed in the active layer 7a, whereas an image 3b′ of the industrial robot is displayed in the passive layer 7b. In this manner, it is possible for the robot programmer to focus the displayed program code in order to check it and perform desired alterations therein, at the same time as the robot programmer “in the background” perceives how a performed alteration in the program code affects the industrial robot controlled by the program code and/or the part of the robot controlled by the program code sequence in question displayed on the screen. The part of the robot that is controlled by the program code sequence in question is for instance marked with a colour marking.

In FIGS. 4-6, a screen surface 2 of a screen 1 comprised in a system according to the invention is schematically illustrated. The inventive system comprises means for displaying on the screen 1 digitally generated information objects, schematically indicated at 3, and one or several digitally generated function objects, schematically indicated at 4a and 4b in FIGS. 4-6.

FIGS. 4-6 further illustrate an embodiment of the invention where the function objects 4a, 4b are of another type than the function objects 4 included in the layer shifting means and are displayed on the screen in a first layer, whereas information objects 3 are displayed in a second layer. The display means 9 are here adapted to display a function object 4a, 4b on an area of the screen that is also available for simultaneous display of information objects 3, the function object 4a, 4b being adapted to be visible to the user and activatable through a pointing device 5 even when an information object 3 simultaneously and visibly to the user is displayed on the screen area covered by the function object 4a, 4b, i.e. even when an information object 3 superimposes the function object 4a, 4b in question. Said information objects 3 are in FIGS. 4-6 displayed with a higher display sharpness than the function objects 4a, 4b, and they are consequently supposed to be present in the for the time being active layer 7a.

Said function objects 4a, 4b are activatable by a user through a pointing device 5, for instance a finger as illustrated in FIGS. 4-6, for control of a system function. In order to make possible this control, the respective function object 4a, 4b is associated with a program sequence responsible for a certain system function.

Said function object 4a is preferably adapted to control a scrolling function, in which case an activation of this function object 4a by means of the pointing device 5 initiates a movement vertically or laterally of at least some of the information objects 3 displayed on the screen. This type of function object is schematically illustrated at 4a₁-4a₄ in FIGS. 4-6. It is however also possible to let the function object 4a, 4b be adapted to control any other type of system function as previously described. The function object is for instance related to a function menu, in which case an activation of the function object by means of the pointing device 5 is adapted to bring forth a presentation on the screen 2 of different selectable system functions. The latter type of function object is schematically illustrated at 4b in FIGS. 4-6. The function objects 4a, 4b suitably have a symbol or text that will help the user to understand which system function the respective function object controls.

Since the function objects 4a, 4b are made to appear to the user less clearly on the screen 1 than the information objects 3, the user's possibility of perceiving the information content of the information objects 3 is not to any appreciable extent disturbed by the function objects 4a, 4b that are simultaneously displayed on the screen, even in case an information object 3 superimposes a function object 4a, 4b. At the same time, it is possible for the user to perceive, when studying the information objects 3 displayed on the screen, the function objects 4a, 4b displayed “in the background” with a lower display sharpness and/or spatial frequency and/or in a weaker shade of colour so that the user is able to rapidly get a chance to activate these function objects 4a, 4b when so desired.

According to an alternative embodiment, said function objects 4a, 4b constitute passive objects as long as the function object 4a, 4b is not activated by the user through the pointing device 5, whereas the function object 4a, 4b is changed into an active object when the function object 4a, 4b is activated by the user through the pointing device 5, so that the activated function object 4a, 4b, and possibly also the rest of the function objects 4a, 4b, will appear more clearly than the information objects 3. In this case, said function objects 4a, 4b consequently also constitute control members included in the layer shifting means for initiation of a shift of layers.

According to an alternative embodiment, a function object 4a, 4b is displayed with a lower sharpness or weaker shade of colour than the information objects 3 as long as the function object 4a, 4b is not activated by the user through the pointing device 5, whereas the display sharpness or shade of colour of said objects 3, 4a, 4b is shifted when the function object 4a, 4b is activated by the user through the pointing device 5, so that the activated function object 4a, 4b, and possibly also the rest of the function objects 4a, 4b, will obtain a display sharpness on the screen that is higher than the display sharpness of the information objects 3 or a stronger shade of colour than these.

In the embodiment illustrated in FIGS. 4-6 are on the screen 1 displayed a first function object 4a₁ adapted to control an upscrolling function, an activation of this first function object by means of the pointing device 5 initiating a movement downwards on the screen of at least some of the information objects 3 displayed on the screen, and a second function object 4a₂ adapted to control a downscrolling function, an activation of this second object by means of the pointing device 5 initiating a movement upwards on the screen of at least some of the information objects 3 displayed on the screen. On the screen 1 are further displayed a third function object 4a₃ adapted to control a first lateral scrolling function, an activation of this third function object by means of the pointing device 5 initiating a movement in one lateral direction on the screen of at least some of the information objects 3 displayed on the screen, and at least one fourth function object 4a₄ adapted to control a second lateral scrolling function, an activation of this fourth function object by means of the pointing device 5 initiating a movement in the other lateral direction on the screen of at least some of the information objects 3 displayed on the screen. On the screen 1 are further displayed function objects 4b of previously described type, which are related to menu functions.

It is of course also possible to let a function object 4a, which is displayed on the screen in accordance with the inventive solution and related to an image scrolling function, be designed as a scroll bar of conventional design.

So as not to appreciably make it more difficult for the user to perceive the information content of the information objects 3 which at a certain moment superimpose a function object 4a, 4b, the function objects 4a, 4b are suitably displayed in a shade of colour that distinguishes them from the information objects 3 and/or with a display sharpness that distinguishes them from the information objects 3. In the latter case, the information objects 3 are suitably displayed with a higher sharpness, i.e. they are adapted to appear clearly and sharply for a user watching the screen 1, whereas the function objects 4a, 4b are displayed with lower sharpness, i.e. they are adapted to appear less clearly and sharply to the user as compared to the information objects 3. The distinguishing display sharpness is for instance produced by displaying the function objects 4a, 4b with a lower resolution than the information objects 3. Since the function objects 4a, 4b are made to appear to the user less clearly on the screen 1 than the information objects 3, the user's possibility of perceiving the information content of the information objects 3 is not to any appreciable extent disturbed by the function objects 4a, 4b that are simultaneously displayed on the screen, even in case an information object 3 superimposes a function object 4a, 4b. At the same time, it is possible for the user to perceive, when studying the information objects 3 displayed on the screen, the function objects 4a, 4b displayed “in the background” with a lower display sharpness or spatial frequency or in a weaker shade of colour so that the user is able to rapidly get a chance to activate these function objects 4a, 4b when so desired.

According to a preferred embodiment of the invention, an information object 3 displayed on the screen is markable by the user through the pointing device 5, in which case an operation performed by the user by means of the pointing device on a part of a marked information object 3, which is displayed on a screen area covered by a function object 4a, 4b and which consequently superimposes this function object 4a, 4b, is adapted to affect the marked information object without activating the function object 4a, 4b. This embodiment will in the following be more closely described with reference to FIGS. 4-6.

When a user with a pointing device, here a finger 5, presses against an area on the screen, which is simultaneously covered by a function object 4a, 4b and an information object 3, the function object 4a, 4b has higher priority than the information object 3, which implies that this pressing will be interpreted by the system as an activation of the function object 4a, 4b and not as a marking of the information object 3. This applies on condition that the information object 3 is not marked through a previous pressing performed by the user on the information object on an area of the screen that is covered by the information object 3 in question and not by a function object 4a, 4b. FIG. 5 illustrates how the user marks an information object 3, in this case a line with for instance program code, by pressing thereon with his finger 5 on an area of the screen that is not covered by a function object 4a, 4b. That the information object 3 has been marked in this manner is for instance indicated in that the information object 3 changes its shade of colour, as illustrated in FIG. 5. When the information object 3 is in the marked state, the information object 3 has higher priority than a function object 4a, 4b, which implies that a pressing performed by the user on an already marked information object 3 will be interpreted by the system as an operation on the information object 3 even though the user presses on the information object 3 on an area of the screen 1 that is also covered by a function object 4a, 4b, as illustrated in FIG. 6. In the case illustrated in FIG. 6, the pressing will consequently result in an operation on the marked information object 3 and not an activation of the function object 4a₁.

In the embodiment illustrated in FIGS. 4-6, the inventive system is intended to constitute a programming device for making possible programming of for instance the movements of an industrial robot, in which case the information objects 3 for instance constitute program code arranged in lines. Other applications of the invention are of course also possible. It may generally be mentioned that the invention is applicable in the display of all sorts of information on a screen. The inventive system is with advantage a text-editing device, in which case the information objects 3 constitute text objects, such as characters arranged in lines or combinations of characters.

With reference to FIGS. 8 and 9, a preferred embodiment of the inventive system is shown, which here constitutes a programming device 10 for programming an industrial robot 20. It is emphasized that the industrial robot illustrated in FIG. 9 only is a very simplified type of industrial robot shown for the purpose of exemplification, and this is consequently not in any way to be interpreted in a manner that is limiting for the invention. In FIG. 9, the device 10 is schematically shown connected to the robot 20 through communication lines 40, 41 and a robot control unit 50. The programming device 10 is, however, with advantage arranged to communicate with the control unit of the robot through a wireless connection, for instance implemented by means of blue-tooth technique. The very schematically shown device 10 is preferably a programming unit, also called Teach Pendant Unit (TPU), and comprises a screen 1, which preferably is a pressure sensitive screen, a so-called touch screen, by means of which it is possible to make inputs to the device 10. However, it is also possible to use a screen sensitive to light or other sorts of inputs, and also a screen that is not intended to be used for any sort of input and consequently only has a display function. Preferably, the device 10 also comprises a control lever 12, by means of which it is possible for an operator 30 to control movements of the robot 20 for programming purposes. It is also possible to let the device 10 comprise emergency breakers, holding devices, and other types of input units, such as function buttons, and be connectable to conventional keyboards and pointing devices, such as a computer mouse (no such features being illustrated).

The device 10 further comprises a data processing unit, schematically indicated by the square 13, to which the screen 1 is connected. The data processing unit 13 preferably comprises any available type of microprocessor and also different types of memories, data busses and other equipment necessary for executing computer-readable program code, for instance in the form of application programs, system programs, operating systems etc. An application program for programming the robot is also included in the device 10, which application program includes a graphical user interface. In this graphical user interface several graphic objects are included, for instance in the form of activatable buttons, text, images, dialogue boxes, activatable icons, etc. These graphic objects, e.g. icons, represent for instance different computer program components, which are preferably implemented in a programming language or the corresponding suitable for the purpose, such as e.g. Java, Java Script, C, C++, Visual Basic. By activating such an information object, for instance by pressing with a finger on the area of the screen 1 where said object is shown, it is possible to initiate execution of the corresponding computer program component in order to program the robot. The execution of these components will either take place in the existing computer processing unit of the device or in other appliances with which the device is communicating. Such a component is for instance used for programming reference positions for the industrial robot. Other components are for instance used for monitoring the status of different parts of the control system of the robot, controlling of mechanical parts included in the robot, controlling/handling of signals, controlling/handling of input/output units, inputting and monitoring of function values, handling of configuration data basis in the control system of the robot. According to the present invention, the different objects are displayed on the screen in the abovedescribed manner.

Software for implementing the inventive method is preferably arranged to be included in a computer program directly loadable into the internal memory of a computer. Such a computer program is suitably provided stored on a computer-readable storage medium such as for instance an optical storage medium in the form of a CD-ROM disc, a DVD disc etc, or a magnetic storage medium in the form of a diskette, a cassette tape etc.

The invention is of course not in any way restricted to the preferred embodiments described above, on the contrary many possibilities to modifications thereof should be apparent to a person skilled in the art without departing from the basic idea of the invention as defined in the appended claims.

1. A system for making possible user interaction with objects on a screen, which systems comprises a screen and means for displaying digitally generated objects on the screen, wherein said display means are adapted to display the objects in two or more transparent and mutually superimposed layers, which layers comprise an active layer and one or several passive layers, the display means being adapted to display the objects that are present in the active layer, here denominated active objects, in such a manner that they are visually distinguished from the objects that are present in a passive layer, here denominated passive objects, and that the system comprises a layer shifting means, which is activatable by a user and adapted to produce a shifting of layers so that the active layer is changed into a passive layer and one of the passive layers is changed into an active layer.

2. The system according to claim 1, wherein the display means are adapted to display active objects with a display sharpness that distinguishes them from passive objects.

3. The system according to claim 2, wherein the display means are adapted to display the active objects with a higher display sharpness than the passive objects.

4. The system according to claim 1, wherein the display means are adapted to display the active objects with a spatial frequency that distinguishes them from passive objects.

5. The system according to claim 4, wherein the display means are adapted to display the active objects with a higher spatial frequency than the passive objects.

6. The system according to claim 1, wherein the display means are adapted to display the active objects in a shade of color that distinguishes them from passive objects.

7. The system according to claim 6, wherein the display means are adapted to display the active objects in a stronger shade of color than the passive objects.

8. The system according to claim 1, wherein the display means are adapted to visually distinguish active objects from passive objects by means of hatching.

9. The system according to claim 1, wherein the layer shifting means comprises digitally generated function objects, the display means being adapted to display a function object on the screen for each layer, and that these function objects are activatable by the user through a pointing device for initiation of a shift of layers.

10. The system according to claim 1, wherein at least one digitally generated function object is activatable by a user through a pointing device for control of a system function, and that the display means are adapted to display said function object on an area of the screen that is also available for the simultaneous display of information objects, said function object being adapted to be visible to the user and activatable through the pointing device even in case an information object simultaneously and visibly to the user is displayed on the screen area covered by the function object.

11. The system according to claim 10, wherein at least one function object is adapted to control a scrolling function, an activation of this function object by means of the pointing device initiating a movement vertically or laterally on the screen of at least some of the information objects that are displayed on the screen.

12. The system according to claim 11, wherein the display means are adapted to display on the screen at least one first function object adapted to control an upscrolling function, an activation of this first function object by means of the pointing device initiating a movement downwards on the screen of at least some of the information objects displayed on the screen, and at least one second function object adapted to control a down scrolling function, an activation of the second function object by means of the pointing device initiating a movement upwards on the screen of at least some of the information objects displayed on the screen.

13. The system according to claim 11, wherein the display means are adapted to display on the screen at least one third function object adapted to control a first lateral scrolling function, an activation of this third function object by means of the pointing device initiating a movement in one lateral direction on the screen of at least some of the information objects displayed on the screen, and at least one fourth function object adapted to control a second lateral scrolling function, and activation of this fourth function object by means of the pointing device initiating a movement in the other lateral direction on the screen of at least some of the information objects displayed on the screen.

14. The system according to claim 11, wherein said function object is a scroll bar.

15. The system according to claim 1, wherein the screen is a touch screen.

16. The system according to claim 1, wherein an information object displayed on the screen is markable by the user through the pointing device, an operation performed by the user by means of the pointing device on a part of a marked information object displayed on a screen area covered by a function object being adapted to affect the marked information object without activating the function object.

17. The system according to claim 1, wherein the display means are adapted to display each function object in a shade of color that distinguishes it from the information objects and/or with a display sharpness that distinguishes it from the information objects.

18. The system according to claim 17, wherein the display means are adapted to produce the distinguishing display sharpness by displaying a function object with a lower resolution than the information objects.

19. The system according to claim 1, wherein the system is a text editing device and the display means are adapted to display information objects in the form of text objects on the screen.

20. The system according to claim 1, wherein the system is a programming device, preferably for programming the movements of an industrial robot.

21. The system according to claim 20, wherein the screen is included in a programming unit designed to be carried by a user during the performance of programming operations.

22. The system according to claim 1, wherein the different layers comprise mutually co-operating objects, which are adapted to co-operate in such a manner that an operation initiated by the user on an object present in a first layer will produce an operation on a co-operating object present in another layer.

23. A method for making possible user interaction with objects on a screen, wherein digitally generated objects are displayed on the screen, wherein the objects are displayed in two or more transparent and mutually superimposed layers, which layers are made to comprise an active layer and one or several passive layers, the objects that are present in the active layer, here denominated active objects, being displayed in such a manner that they are visually distinguished from the objects that are present in a passive layer, here denominated passive objects, and that a layer shifting means, which is activatable by a user, is made to achieve a shift of layers when being activated so that the active layer is changed into a passive layer and one of the passive layers is changed into an active layer.

24. The method according to claim 23, wherein active objects are displayed with a display sharpness that distinguishes them from passive objects.

25. The method according to claim 24, wherein the active objects are displayed with a higher display sharpness than the passive objects.

26. The method according to claim 23, wherein active objects are displayed with a spatial frequency that distinguishes them from passive objects.

27. The method according to claim 26, wherein the active objects are displayed with a higher spatial frequency than the passive objects.

28. The method according to claim 23, wherein active objects are displayed in a shade of colour color that distinguishes them from passive objects.

29. The method according to claim 28, wherein the active objects are displayed in a stronger shade of color than the passive objects.

30. The method according to claim 23, wherein active objects are visually distinguished from passive objects by means of hatching.

31. The method according to claim 23, wherein digitally generated function objects are displayed on the screen, each layer being associated to a specific function object, and that these function objects are activatable by the user through a pointing device for initiation of a shift of layers.

32. The method according to claim 23, wherein at least one digitally generated function object is displayed on the screen, which function object is activatable by a user through a pointing device for control of a system function, and that this function object is displayed on an area of the screen that is also available for simultaneous display of information objects, this function object being made to be visible to the user and affectable through the pointing device even in case an information object simultaneously and visibly to the user is displayed on the screen area covered by the function object.

33. The method according to claim 32, wherein at least one function object controls a scrolling function, an activation of this function object by means of the pointing device initiating a movement vertically or laterally on the screen of at least some of the information objects displayed on the screen.

34. The method according to claim 33, wherein there are displayed on the screen at least one first function object related to an upscrolling function, an activation of this first function object by means of the pointing device initiating a movement downwards on the screen of at least some of the information objects displayed on the screen, and at least one second function object related to a downscrolling function, and activation of this second function object by means of the pointing device initiating a movement upwards on the screen of at least some of the information objects displayed on the screen.

35. The method according to claim 33, wherein there are displayed on the screen at least one third function object related to a first lateral scrolling function, an activation of this third function object by means of the pointing device initiating a movement in one lateral direction on the screen of at least some of the information objects displayed on the screen, and at least one fourth function object related to a second lateral scrolling function, an activation of this fourth function object by means of the pointing device initiating a movement in the other lateral direction on the screen of at least some of the information objects displayed on the screen.

36. The method according to claim 33, wherein the function object is displayed in the form of a scroll bar.

37. The method according to any of claim 32, wherein the screen is included in a text editing device and information objects in the form of text objects are displayed on the screen.

38. The method according to claim 32, wherein the screen is included in a programming device, preferably for programming the movements of an industrial robot, information objects in the form of program code being displayed on the screen.

39. The method according to claim 32, wherein an information object displayed on the screen is made to be markable by the user through the pointing device, an operation performed by the user through the pointing device on a part of a marked information object displayed on a screen area that is covered by a function object being made to affect the marked information object without the function object being activated.

40. The method according to claim 32, wherein each function object is displayed in a shade of color that distinguishes it from the information objects and/or with a display sharpness that distinguishes it from the information objects.

41. The method according to claim 40, wherein the display sharpness that distinguishes from the information objects is produced in that a function object is displayed with a lower resolution than the information objects.

42. The method according to claim 39, wherein the screen is a touch screen and the respective function object is adapted as to its surface size for co-operation with a pointing device in the form of a finger.

43. The method according to claim 32, wherein the screen is included in a programming device, preferably for programming the movements of an industrial robot and objects in the form of program code are displayed in any of said layers.

44. The method according to claim 32, wherein the different layers are made to comprise mutually co-operating objects, which are made to co-operate in such a manner that an operation initiated by the user on an object present in a first layer will produce an operation on a co-operating object present in a second layer.

45. A computer program directly loadable into the internal memory of a computer, which computer program comprises software for implementing a method according to claim 23.

46. A computer-readable medium having stored thereon a computer program intended to make a computer implement a method according to claim 23.

47. Use of a system according to claim 1 for programming the movements of an industrial robot.
